(19) United States
(12) Patent Application Publication
(10) Pub. No.: US 2016/0031037 A1
(43) Pub. Date: Feb. 4, 2016

(54) LASER STRUCTURE

(71) Applicant: WECON AUTOMATION CORP., Hsinchu City (TW)

(72) Inventors: CHING TSUNG CHANG, Hsinchu City (TW); CHAO CHING WU, Hsinchu City (TW)

(21) Appl. No.: 14/551,005

(22) Filed: Nov. 22, 2014

(30) Foreign Application Priority Data
Jul. 29, 2014 (TW) 103125781

(51) Int. Cl. B23K 26/00; B23K 26/57; B23K 26/38; B23K 26/046

(52) U.S. Cl. CPC B23K 26/0063; B23K 26/046; B23K 26/57; B23K 26/38

(57) ABSTRACT

The present invention relates to an improved laser structure comprising a laser generation module and an optical component. The laser generation module outputs laser beams to the optical component. A composite substrate to be cut comprises at least two board layers of different materials, and an upper surface of each of the at least two board layers is a cutting starting point of the each of the at least two board layers. The optical component is used to transform the laser beams to laser beams having at least two focal depths so as to be respectively focused on the upper surface of the each of the at least two board layers mentioned above, and to achieve effect of enhancing cutting efficiency of the composite substrate.

### BACKGROUND OF THE INVENTION

1. Field of the Invention

The present invention relates to an improved laser structure, particularly with regard to an improved laser structure suitable for cutting of composite substrates.

2. The Related Arts

Traditional cutting practices of substrates are usually to use a diamond knife to mechanically cut out predetermined shapes from the substrates. The traditional mechanical cutting process is much time consuming, and mechanical cutting can easily cause damages onto the substrates.

In recent years, since laser cutting technology has become much mature day by day, such technology gradually replaces the traditional mechanical cutting methods. Advantages of laser cutting include fast cutting. As a result, laser cutting has played an indispensable important role in the cutting technical area.

However, for laser cutting operations on composite substrates, since material and thickness of layers of a composite substrate are not the same, separate alignment, focusing and adjustment of laser energy as required for each layer of the composite substrate during its laser cutting process will be necessary. As a result, its cutting process becomes labor-consuming, time-consuming and producing efficiency deteriorating tendency.

In view of the above problems, the named inventors of the present invention make painstaking efforts to research and study in cooperation with application of related technical theory and rules. An improved laser structure which can effectively improve the above drawbacks is finally proposed. An optical component is used to transform laser beams from laser sources to laser beams having at least two focal depths so as to be respectively focused on an upper surface of each of the layers of the composite substrate. By scoring a notch on a first surface of the substrate greater than or equal to a notch on a second surface of the substrate, efficiency of laser cutting is successfully enhanced.

### SUMMARY OF THE INVENTION

The object of the present invention is as follows. By a laser generation module outputting laser beams to an optical component, the optical component is used to transform the laser beams to laser beams having at least two focal depths so as to be respectively focused on an upper surface of each of board layers of composite substrates. As a result, effect of enhancing cutting efficiency of the composite substrate is achieved.

Technical means adopted to achieve the above object of the present invention is to provide an improved laser structure. The laser structure comprises a laser generation module, and the laser generation module outputs laser beams to an optical component. A composite substrate to be cut comprises at least two board layers of different materials, and an upper surface of each of the at least two board layers is a cutting starting point of the each of the at least two board layers. The optical component is used to transform the laser beams to laser beams having at least two focal depths so as to be respectively focused on the upper surface of the each of the at least two board layers mentioned above.

In an embodiment of the present invention, the optical component comprises a plurality of different curvatures.

In an embodiment of the present invention, the optical component comprises a beam splitter and a focal convergent lens, the laser beams output from the laser generation module sequentially pass through the beam splitter and the focal convergent lens, and the focal convergent lens comprises a plurality of different curvatures.

In an embodiment of the present invention, the each of the at least two board layers is made from a selective one of metal material, plastic material, glass material and ceramic material.

In an embodiment of the present invention, the laser beams are transformed by the optical component to laser beams having at least two focal depths in order to be respectively focused on the upper surfaces of the at least two board layers and to form at least two cutting channels.

In an embodiment of the present invention, the at least two cutting channels are formed simultaneously.

In an embodiment of the present invention, the at least two cutting channels are formed successively.

In an embodiment of the present invention, laser energy of the laser beams focused respectively on the upper surfaces of the at least two board layers is equal to one another.

In an embodiment of the present invention, laser energy of the laser beams focused respectively on the upper surfaces of the at least two board layers is unequal to one another.

In an embodiment of the present invention, the laser generation module is electrically connected to a control unit, and the control unit transmits an action signal to make the laser generation module outputting laser beams based on the action signal.

In order to more clearly describe the improved laser structure of the present invention, the present invention will be further explained via the following embodiments and the attached drawings.

### BRIEF DESCRIPTION OF THE DRAWINGS

FIG. 1 shows a schematic side view of an improved laser structure in accordance with an embodiment of the present invention; and

FIG. 2 shows a schematic side view of composite substrate cutting of the improved laser structure in accordance with an embodiment of the present invention.

### DETAILED DESCRIPTION OF PREFERRED EMBODIMENT

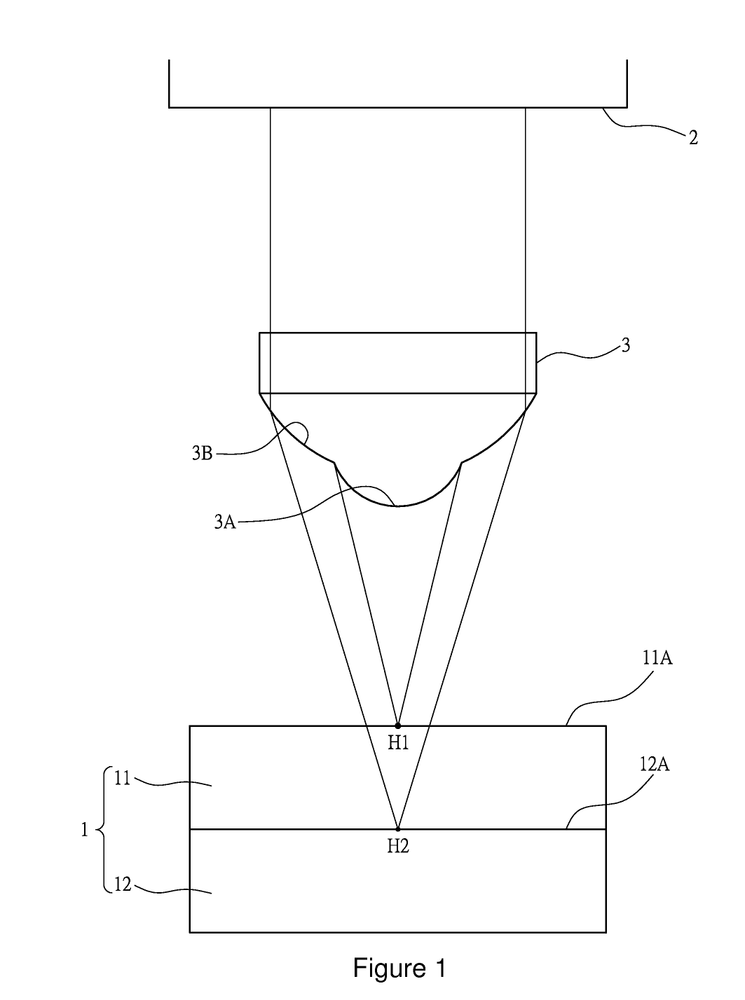

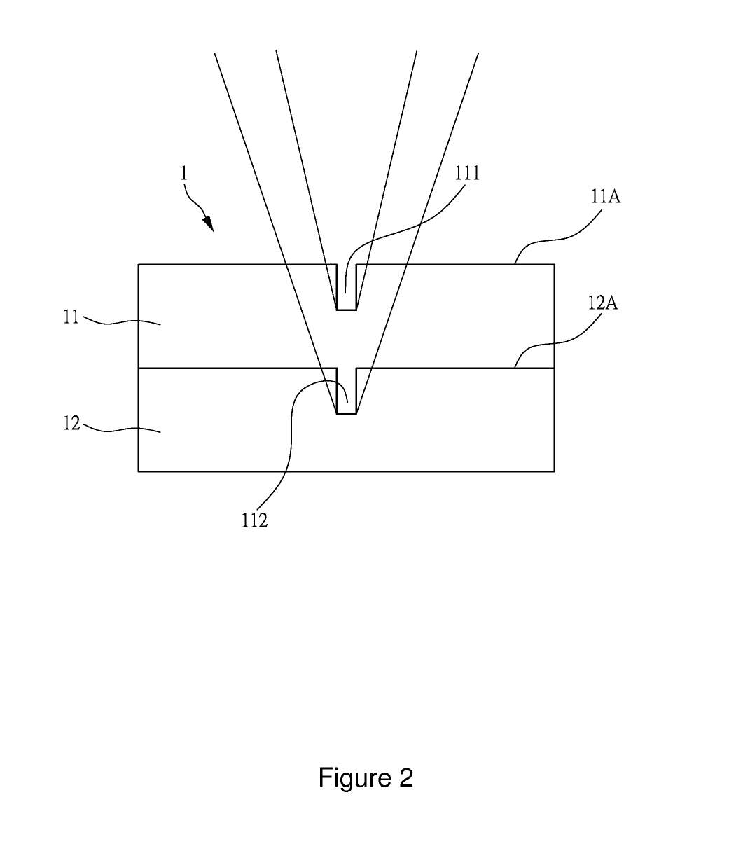

With reference to FIGS. 1 to 2, an improved laser structure used to form cutting channels (or known as “cutting grooves”) on a composite substrate 1 in accordance with an embodiment of the present invention comprises a laser generation module 2, an optical component 3, and a control unit (not shown).

The laser generation module 2 mentioned above can be a solid-state laser, liquid laser or gas laser in the embodiment. The laser generation module 2 is electrically connected to the control unit, for example, a host computer. The control unit transmits an action signal to make the laser generation module 2 outputting laser beams based on the action signal. The laser generation module 2 outputs a laser beam to the optical component 3, which can be an optical lens or a prism. The composite substrate 1 mentioned above comprises at least two board layers of different materials, such as metal material, plastic material, glass material, ceramic material, etc. In the current embodiment, the composite substrate 1 comprises a first board layer 11 of glass material and the second board layer 12 of ceramic material. An upper surface 11A, 12A of each of the board layers 11, 12 mentioned above is a cutting starting point of the each of the board layers 11, 12. Laser beams output from the laser generation module 2 pass through the optical component 3 mentioned above. Based on a board layer amount of the composite substrate 1, at least two focal depths of laser beams are formed to focus the laser beams on the upper surface 11A, 12A of the each of the board layers 11, 12 since the optical component 3 mentioned above comprises a plurality of different curvatures to transform the laser beams. In the current embodiment, since the composite substrate 1 mentioned above is a two-layer structure, laser beams output from the laser generation module 2 are transformed via a first curvature 3A and a second curvature 3B of two different curvatures of the optical component 3 mentioned above to laser beams having a first focal depth H1 and a second focal depth H2 in order to be respectively focused on the upper surface 11A of the first board layer 11 and the upper surface 12A of the second board layer 12. Among the above, the optical component 3 mentioned above is able to transform laser beams passing therethrough to form laser beams having at least two focal depths in order to be respectively focused on the upper surfaces 11A, 12A of the at least two board layers 11, 12 mentioned above and to form at least two cutting channels 111, 112 for executing a cutting operation of the composite substrate 1. As a result, the cutting process is time-saving and has enhanced cutting efficiency. In the current embodiment, the optical component 3 mentioned above is able to transform the laser beams to be respectively focused on the upper surface 11A of the first board layer 11 and the upper surface 12A of the second board layer 12 and to respectively form a first cutting channel 111 and a second cutting channel 112 thereon. The cutting channels 111, 112 mentioned above may be formed simultaneously, and also can be successively formed. Simultaneously forming is preferred in order to greatly save time and enhance cutting efficiency. Furthermore, laser energy of the laser beams focused respectively on the upper surfaces of the board layers mentioned above which the laser beam mentioned above can be equal or unequal according to materials of the board layers 11, 12 of the composite substrate 1 and widths of cutting channels 111, 112 preset to be cut.

In a further preferred embodiment, since the composite substrate 1 mentioned above is a two-layer structure, the optical component 3 mentioned above comprises a beam splitter and a focal convergent lens. The laser beams output from the laser generation module 2 sequentially pass through the beam splitter and the focal convergent lens, and the laser beams mentioned above are at first split by the beam splitter and then pass through the focal convergent lens having the first curvature 3A and the second curvature 3B of two different curvatures. The laser beams are transformed by the focal convergent lens to laser beams having the first focal depth H1 and the second focal depth H2 so as to be respectively focused on the upper surface 11A of the first board layer 11 and the upper surface 12A of the second board layer 12.

In manufacturing process operations, the composite substrate 1 desired to be cut is fixed on a base (not shown), and the base mentioned above comprises and is installed with a fixing piece, for example, a clamp or locking device, used to fix the composite substrate 1 onto the base. Alternatively, the base mentioned above comprises and is installed with a vacuum system to fix the composite substrate 1 onto on the base via vacuum drawing attachment. Meanwhile, information related to the composite substrate 1 is typed to be input in the control unit, for example, its size, thickness, a number of board layers, material and so on. Thereafter, an image sensor is used to proceed an alignment procedure, and the image sensor is disposed at a top of the base. The upper surface 11A of the first board layer 11 of the composite substrate 1 mentioned above comprises and is installed with an alignment key, for example, an engraved cross pattern disposed at a board edge of the composite substrate 1. In the alignment procedure mentioned above, the alignment key of the composite substrate 1 is aligned by the image sensor, and then the control unit receives image signals of the image sensor and transmits the action signal to the laser generation module 2 to make the laser generation module 2 outputting laser beams. The laser beams mentioned above pass through the first curvature 3A and the second curvature 3B of two different curvatures of the optical component 3 to make the laser beams transformed to laser beams having the first focal depth H1 and the second focal depth H2 so as to be respectively focused on the upper surface 11A of the first board layer 11 to be cut and the upper surface 12A of the second board layer 12 to be cut, and to proceed cutting for forming the first cutting channel 111 and the second cutting channel 121 thereon, respectively.

The present invention is characterized as follows. The laser generation module 2 outputs laser beams to the optical component 3, and the optical component 3 is used to transform the laser beams to laser beams having at least two focal depths so as to be respectively focused on the upper surface 11A, 12A of each of the at least two board layers 11, 12 mentioned above to achieve effect of enhancing cutting efficiency of the composite substrate 1.

Although the preferred embodiments of the present invention are described as above, they are not intended to limit the present invention. Any person skilled in this art of the present invention can make some changes or improvements according to shapes, structures, features and inventive spirits as depicted in the above descriptions of the present invention without departing from the inventive spirit and scope of the present invention, and the changes or improvements are still covered within the inventive spirit of the present invention and the scope as defined in the following claims. Therefore, the patent claim scope of the present invention is defined by claims as appended in the specification of the present invention.

What is claimed is:

1. A laser structure used for form cutting channels on a composite substrate, comprising a laser generation module, and the laser generation module outputting laser beams to an optical component, wherein the composite substrate comprises at least two board layers of different materials, and an upper surface of each of the at least two board layers is a cutting starting point of the each of the at least two board layers, the optical component is to transform the laser beams to laser beams having at least two focal depths and being respectively focused on the upper surface of the each of the at least two board layers.

2. The laser structure as claimed in claim 1, wherein the optical component comprises a plurality of different curvatures.

3. The laser structure as claimed in claim 1, wherein the optical component comprises a beam splitter and a focal convergent lens, the laser beams output from the laser generation module sequentially pass through the beam splitter and the focal convergent lens, and the focal convergent lens comprises a plurality of different curvatures.

4. The laser structure as claimed in claim 1, wherein the each of the at least two board layers are made from a selective one of metal material, plastic material, glass material and ceramic material.

5. The laser structure as claimed in claim 1, wherein the laser beams are transformed by the optical component to laser beams having at least two focal depths in order to be respectively focused on the upper surfaces of the at least two board layers and to form at least two cutting channels.

6. The laser structure as claimed in claim 5, wherein the at least two cutting channels are formed simultaneously.

7. The laser structure as claimed in claim 5, wherein the at least two cutting channels are formed successively.

8. The laser structure as claimed in claim 1, wherein laser energy of the laser beams focused respectively on the upper surfaces of the at least two board layers is equal to one another.

9. The laser structure as claimed in claim 1, wherein laser energy of the laser beams focused respectively on the upper surfaces of the at least two board layers is unequal to one another.

10. The laser structure as claimed in claim 1, wherein the laser generation module is electrically connected to a control unit, and the control unit transmits an action signal to make the laser generation module outputting laser beams based on the action signal.
